(19) United States
(12) Patent Application Publication
(10) Pub. No.: US 2025/0094531 A1
(43) Pub. Date: Mar. 20, 2025

(54) INFORMATION PROCESSING APPARATUS

(71) Applicant: HITACHI, Ltd., Tokyo (JP)

(72) Inventor: Takuya OKUYAMA, Santa Clara, CA (US)

(21) Appl. No.: 18/368,802

(22) Filed: Sep. 15, 2023

(51) Int. Cl. G06F 17/16

(52) U.S. Cl. CPC G06F 17/16

(57) ABSTRACT

Aspects of the present disclosure can involve systems and methods for accelerating a process to search for optimal solutions for interaction models, the process involving iterative matrix multiplication between a first matrix and a second matrix, which include replacing the first matrix with a first approximate matrix and the second matrix with a second approximate matrix through adding a first set of constant values to the first matrix and a second set of constant values to the second matrix; executing a Monte Carlo Approximate Matrix Multiplication between the first approximate matrix and the second approximate matrix to generate an approximate matrix product; executing the process to search for the optimal solutions based on the approximate matrix product according to the interaction models; and providing the optimal solutions found from the process.

### BACKGROUND

### Field

The present disclosure is generally directed to parallel computing, and more specifically, to graphical processing units (GPUs) and operations for matrix multiplication.

### Related Art

Complementary metal-oxide semiconductor (CMOS) Annealing is a technique that implements Ising computing principles into digital circuits. Ising computing is a method that focuses on finding the ground state of Ising models with non-planar graphs, which is an NP-hard problem. This computational principle can be applied to solve other combinatorial optimization problems efficiently, making it suitable for improving productivity, resource conservation, and efficient system operation in thermal power plants and urban infrastructure.

Described herein is the CMOS Annealing machine and momentum annealing (MA). Both are CMOS Annealing technologies, but have distinct characteristics that make them suitable for different problems. The CMOS annealing machine is an annealing machine that utilizes semiconductor circuits and is superior in terms of power performance and scalability, albeit with constraints on the optimization problems it can handle due to implementation reasons. On the other hand, MA is an algorithm suitable for computers with many cores, such as GPUs, and can address the ground-state search problem of the Ising model with arbitrary connections, making it applicable to various optimization problems. The differences in the characteristics of each technique provided as follows.

The CMOS Annealing machine is a computational device that efficiently and energetically solves the ground state search problem of non-planar Ising models with an external magnetic field known as NP-hard. The Hamiltonian of the Ising model is represented as follows:

$$H = - {\sum }_{i < j} {J}_{ij} {σ}_{j} {σ}_{j} - {\sum }_{i < j} {h}_{i} {σ}_{i} \qquad ( 2.1 )$$

The outline of the CMOS Annealing machine can be described as follows. Spin states are simulated using memory cells in a spin array, and the states of spins (−1/+1) correspond to the two states (0/1) of memory cells. Furthermore, interaction coefficients Jᵢⱼ and external magnetic field coefficients hi are stored in the spin array's memory cells. This structure represents the Ising model with a non-planar graph. The components of the Ising model, such as spin i, interaction coefficient Jᵢⱼ, and external magnetic field coefficient hᵢ, are all realized in memory cells, and their values are read and written through an SRAM-compatible interface (address bus, data bus, Read/Write control, and Input/Output clock). When searching for the ground state of the Ising model, the host computer controls the SRAM-compatible interface to write the initial values of spins, external magnetic field coefficients, and interaction coefficients. The solution is obtained by reading the values of spins after completing the ground state search.

FIG. 1 illustrates an example computing flow of the CMOS Annealing machine. First, the desired combinatorial optimization problem is formulated as a ground state search problem of the Ising model (Ising formulation). For example, the traveling salesperson problem (TSP), a representative combinatorial optimization problem, can also be converted into a ground state search problem of the Ising model. Next, the coefficients of the Ising model obtained from the above process are written into the CMOS annealing machine (graph embedding), and the ground state search is performed (solution search). The ground state of the Ising model obtained corresponds to the solution of the original problem, such as TSP. Therefore, the desired combinatorial optimization problem can be solved by decoding the received search results.

FIGS. 2A and 2B illustrate the conversion of the Ising model into a bipartite graph. MA algorithm is a method for rapidly solving the ground state search problem of the Ising model by utilizing large-scale parallel computing. In this algorithm, the ground state of the Ising model on a bipartite graph (FIG. 2B) is searched to find the ground state of the fully connected Ising model (FIG. 2A).

Specifically, FIG. 2A illustrates a fully connected Ising model with N=7, and FIG. 2B illustrates an Ising model on a complete bipartite graph G. If the values of the bold couplings are sufficiently large, the spin configurations on the left will match those on the right in the ground state.

The interaction wᵢ between the spin σᵢ^{L} and the spin σᵢ^{R} (indicated by the bold line in FIG. 2B) is determined to satisfy the following equation, which ensures that the ground state of the Ising model on the complete bipartite graph coincides with that of the original problem, the fully connected Ising model:

$${w}_{i} = \{ \begin{matrix}{\sum }_{{v}_{j} ∈ V} \vert {J}_{ij} \vert - \frac{1}{2} {\sum }_{{v}_{j} ∈ C} \vert {J}_{ij} \vert & ( {v}_{i} ∈ C ) \\ \frac{λ}{2} & ( {v}_{i} ∉ C )\end{matrix} , \qquad ( 2.2 )$$

where λ is the maximum eigenvalue of −J, and C is an arbitrary subset of the vertex set V. Equation (2.2) allows for the simultaneous updating of all spins for the fully connected Ising model. The computational flow is summarized in FIG. 3, and the Ising problem represented as a mathematical model for optimization is shown with respect to FIG. 4.

In the annealing field, annealing machines utilizing digital circuits and D-Wave have been commercialized, which has achieved quantum annealing using analog devices employing quantum fluctuations.

### SUMMARY

FIG. 5 illustrates the example process of executing CMOS Annealing through the Ising formulation and annealing technology. At first, the combinatorial optimization problem is transformed into an Ising problem, which can then be solved by CMOS annealing. CMOS Annealing repeatedly performs exact matrix multiplication. The acceleration of matrix products can be achieved by executing on GPUs, but limits have been reached. A faster matrix multiplication method is required to reduce the overall calculation time of CMOS Annealing. As shown in the performance comparison with the conventional method of FIG. 6, the momentum annealing technique can operate up to 250 times faster than traditional computational techniques.

The example implementations described herein aim to reduce the expected square error in Monte Carlo Approximate Matrix Multiplication (AMM) without significantly increasing the computation time. This is achieved by exploiting additional information used in the conventional AMM. The essential steps of the method can be summarized as follows:
Define matrices X and Y by adding or subtracting constant values from the columns of A and rows of B, respectively, using mean values and perturbation vectors.

$$X := A - {{e}_{m} ( α + x )}^{T} , Y := B - ( β + y ) {e}_{n}^{T} ,$$

Utilize the fact that certain terms in the matrix product AB can be computed using matrix-vector and inner products instead of matrix-matrix products. This reduces the number of computations required for these terms, resulting in a more efficient calculation.

Evaluate the AMM of matrices X and Y instead of directly using A and B. This approximation relies solely on the error of XY, which is shown to be lower than directly using AMM on AB.

Analyze the expected square error of the Monte Carlo AMM for computing XY. The error, represented by E, is proportional to the difference between the squared sum of absolute values and the squared norm of XY.

By presenting several theorems, the example implementations reduce the expected square error without significantly increasing the computation time. This provides a more accurate approximation of matrix products, which is crucial in various applications involving eigenvalue computation, combinatorial optimization algorithms, and other information processing tasks.

The example implementations introduce the incorporation of a low computational cost preprocessing technique into existing matrix multiplication algorithms as an approximation method. By employing this technique, the optimization time of CMOS Annealing can be accelerated.

While numerous algorithms for approximate matrix multiplication have been proposed, such applications are specifically designed (e.g., specifically designed for efficient execution on Central Processing Units or CPUs). However, as CMOS Annealing leverages GPUs' extensive parallel computing capabilities, it is imperative to have an approximation algorithm that operates swiftly on GPU platforms. Example implementations of such an algorithm is presented.

Aspects of the present disclosure can involve a method for accelerating a process to search for optimal solutions for interaction models, the process involving iterative matrix multiplication between a first matrix and a second matrix, the method including replacing the first matrix with a first approximate matrix and the second matrix with a second approximate matrix through adding a first set of constant values to the first matrix and a second set of constant values to the second matrix; executing a Monte Carlo Approximate Matrix Multiplication between the first approximate matrix and the second approximate matrix to generate an approximate matrix product; executing the process to search for the optimal solutions based on the approximate matrix product according to the interaction models; and providing the optimal solutions found from the process.

Aspects of the present disclosure can involve a system for accelerating a process to search for optimal solutions for interaction models, the process involving iterative matrix multiplication between a first matrix and a second matrix, the system including means for replacing the first matrix with a first approximate matrix and the second matrix with a second approximate matrix through adding a first set of constant values to the first matrix and a second set of constant values to the second matrix; means for executing a Monte Carlo Approximate Matrix Multiplication between the first approximate matrix and the second approximate matrix to generate an approximate matrix product; means for executing the process to search for the optimal solutions based on the approximate matrix product according to the interaction models; and means for providing the optimal solutions found from the process.

Aspects of the present disclosure can involve a non-transitory computer readable medium, storing instructions for accelerating a process to search for optimal solutions for interaction models, the process involving iterative matrix multiplication between a first matrix and a second matrix, the instructions including replacing the first matrix with a first approximate matrix and the second matrix with a second approximate matrix through adding a first set of constant values to the first matrix and a second set of constant values to the second matrix; executing a Monte Carlo Approximate Matrix Multiplication between the first approximate matrix and the second approximate matrix to generate an approximate matrix product; executing the process to search for the optimal solutions based on the approximate matrix product according to the interaction models; and providing the optimal solutions found from the process.

Aspects of the present disclosure can involve an information processing device configured to accelerate a process to search for optimal solutions for interaction models, the process involving iterative matrix multiplication between a first matrix and a second matrix, the information processing device involving a processor, configured to control one or more calculation devices to execute, using parallel processing, replacing the first matrix with a first approximate matrix and the second matrix with a second approximate matrix through adding a first set of constant values to the first matrix and a second set of constant values to the second matrix; executing a Monte Carlo Approximate Matrix Multiplication between the first approximate matrix and the second approximate matrix to generate an approximate matrix product; executing the process to search for the optimal solutions based on the approximate matrix product according to the interaction models; and providing the optimal solutions found from the process.

### BRIEF DESCRIPTION OF DRAWINGS

FIG. 1 illustrates an example computing flow of the CMOS Annealing machine.

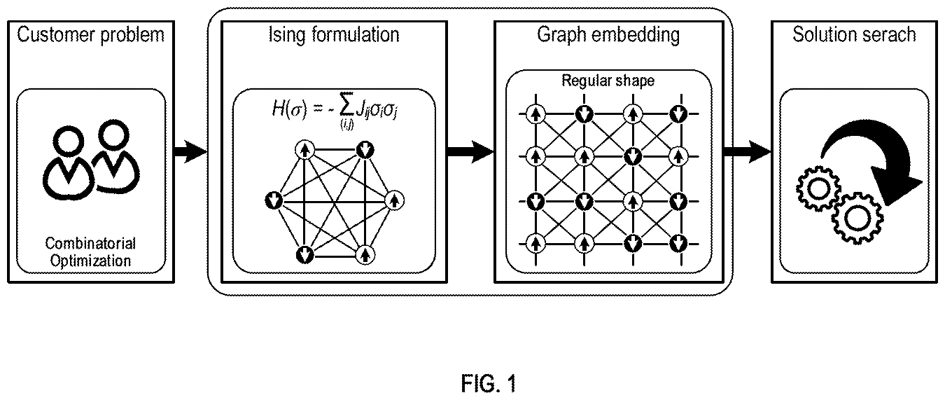

FIGS. 2A and 2B illustrate the conversion of the Ising model into a bipartite graph.

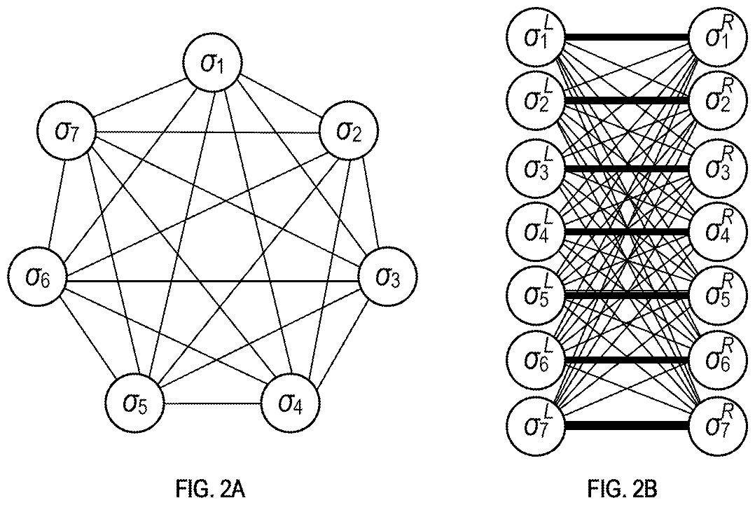

FIG. 3 illustrates an example computing flow of Momentum Annealing.

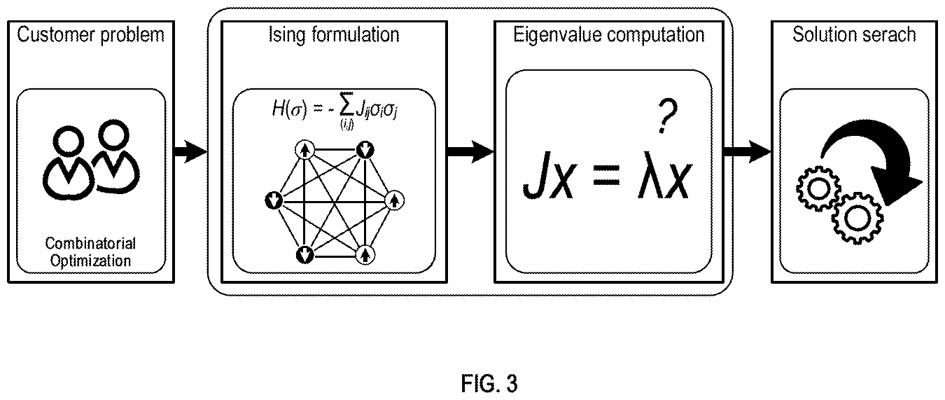

FIG. 4 illustrates an example Ising problem as a mathematical model for optimization.

FIG. 5 illustrates an example optimization flow by CMOS annealing.

FIG. 6 illustrates an example performance comparison of momentum annealing versus the conventional techniques.

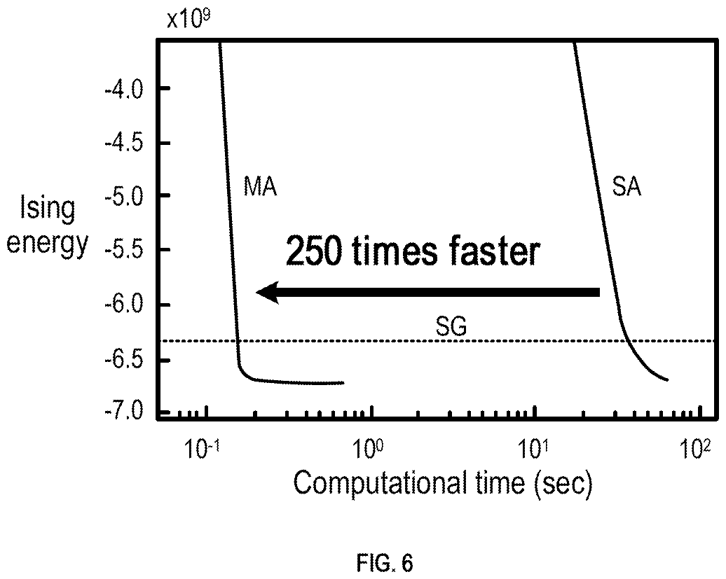

FIG. 7 illustrates an example pseudo code (Algorithm 1) of the Monte Carlo AMM, in accordance with an example implementation.

FIG. 8 illustrates an example of pseudo code (Algorithm 2) of the Monte Carlo AMM with proposed pre-processing, in accordance with an example implementation.

FIG. 9 illustrates an example of the overall process, in accordance with an example implementation.

FIG. 10 illustrates an example of the optimal solution search process, in accordance with an example implementation.

FIG. 11A and FIG. 11B illustrates an example of an improvement in computation time through use of the example implementations in comparison to the related art.

FIG. 12 illustrates a block diagram illustrating a schematic configuration of an information processing device upon which example implementations can be implemented.

FIG. 13 is a block diagram illustrating a calculation system upon which example implementations can be implemented.

FIG. 14 is a detailed block diagram of the calculation system upon which example implementations can be applied.

FIG. 15 is a block diagram of a unit constituting the calculation system upon which example implementations can be applied.

### DETAILED DESCRIPTION OF THE INVENTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means or can be implemented through a desired algorithm. Example implementations as described herein can be utilized either singularly or in combination and the functionality of the example implementations can be implemented through any means according to the desired implementations.

### Theory of a Monte Carlo AMM

Example implementations described herein involve an apparatus that performs the approximate matrix calculation shown in the following pseudo code. In the following, the theory of a Monte Carlo method for calculating an AMM of A∈ [symbol] ^{m×k} and B∈ [symbol] ^{k×n} is described. For any real matrix M, we let M^{(l)} and M₍ₗ₎ denote the l-th column and l-th row of matrix M, respectively. Let ∥M∥ denote Frobenius norm of M.

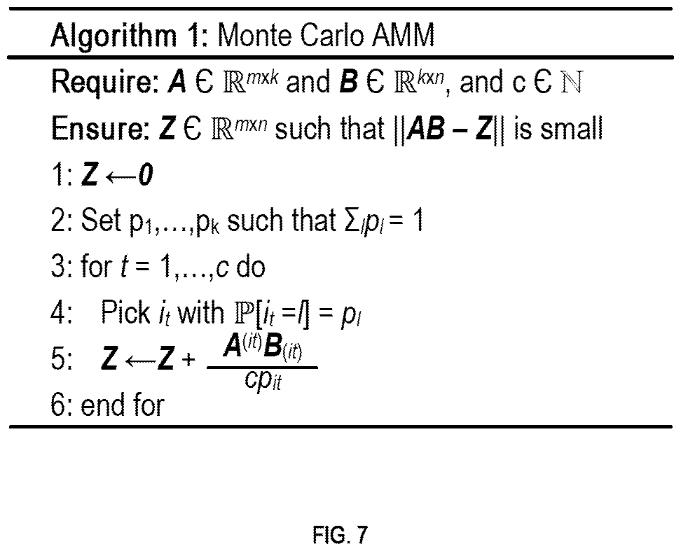

FIG. 7 illustrates an example pseudo code (Algorithm 1) of the Monte Carlo AMM, in accordance with an example implementation. It is a randomized algorithm designed to return an approximate solution Z that is close to the exact one AB with a high probability. It is proved that the expected square Frobenius error can be evaluated between AB and Z as

$$𝔼 [ {‖ AB - Z ‖}^{2} ] = \frac{1}{c} \{ {\sum }_{l = 1}^{k} \frac{{\vert {A}^{( l )} \vert}^{2} {\vert {B}_{( l )} \vert}^{2}}{{p}_{l}} - {‖ AB ‖}^{2} \} . \qquad ( 3.1 )$$

Error can be minimized if

$${p}_{l} = {p}_{l}^{opt} := \frac{\vert {A}^{( l )} \vert \vert {B}_{( l )} \vert}{{\sum }_{l = 1}^{k} \vert {A}^{( l )} \vert \vert {B}_{( l )} \vert} , \qquad ( 3.2 )$$

and in that case the error is as follows.

$$𝔼 [ {‖ AB - Z ‖}^{2} ] {\vert}_{{p}_{l} = {p}_{l}^{opt}} = \frac{1}{c} \{ {( {\sum }_{l = 1}^{k} \vert {A}^{( l )} \vert \vert {B}_{( l )} \vert )}^{2} - {‖ AB ‖}^{2} \} \qquad ( 3.3 )$$

The statement that AB=∈ₗ₌₁^{k}A^{(l)}B₍ₗ₎ and Eq. (3.3) imply that Algorithm 1 with the optimal Monte Carlo sampling is designed to assign a higher probability to columns/rows with larger Frobenius norms during sampling and to compute their product as an approximate solution.

### Extended Monte Carlo AMI

A straightforward method to reduce the expected square error is to increase the number of sampling iterations c. The error decreases inversely with the number of iterations. However, increasing c results in a longer computation time for the Monte Carlo AMM. Therefore, as described herein, example implementations can involve a method to reduce the expected square error without significantly increasing the computational time by further exploiting the information used in the conventional AMM.

$$X := A - {{e}_{m} ( α + x )}^{T} , Y := B - ( β + y ) {e}_{n}^{T} \qquad ( 3.4 )$$

where α=[α₁ . . . αₖ]^{T}, β:=[β₁ . . . βₖ]^{T}, x:=[x₁ . . . xₖ]^{T}, y:=[y₁ . . . yₖ]^{T}, and eₗ is 1-dimensional vector whose all elements are one. These mean that we obtain X and Y by subtracting a constant value αᵢ+xᵢ from i-th column of A and βᵢ+yᵢ from i-th row of B. Then,

$$\begin{matrix}AB = ( X + {{e}_{m} ( α + x )}^{T} ) ( Y + ( β + y ) {e}_{n}^{T} ) \\ = XY + ( X ( β + y ) ) {e}_{n}^{T} + {e}_{m} ( {( α + x )}^{T} Y ) + \\ {e}_{m} ( {( α + x )}^{T} ( β + y ) ) {e}_{n}^{T}\end{matrix} \qquad ( 3.5 )$$

The calculation of the second, third, and fourth terms of Eq. (3.5) can be done using matrix-vector and inner products rather than matrix-matrix products. By exploiting this fact, given A, B, x, and y, these terms can be accurately computed with a reduced number of computations. Thus, example implementations can be used to compute an AMM of the matrices X and Y The expected error of this approximation depends only on the error of XY. To simplify the notation, define A′:=A−eₘα^{T} and B′:=B−βeₙ^{T}. The matrices A′ and B′ are constant, and important fact is that the column sums of A′ and the row sums of B′ are all zero.

Considering the discussion on Eq. (3.3), the expected square error of the Monte Carlo AMM for computing XY is given by

$$\begin{matrix}E := {( {\sum }_{l = 1}^{k} \vert {X}^{( l )} \vert \vert {Y}_{( l )} \vert )}^{2} - {‖ XY ‖}^{2} \\ = {( {\sum }_{l = 1}^{k} \vert {A}^{′ ( l )} - {x}_{l} {e}_{m} \vert \vert {B}_{( l )}^{′ T} - {y}_{l} {e}_{n} \vert )}^{2} - \\ {‖ ( {A}^{′} - {e}_{m} {x}^{T} ) ( {B}^{′} - y {e}_{n}^{T} ) ‖}^{2} .\end{matrix} \qquad ( 3.6 )$$

Here, the following theorem is provided: The function E is globally optimal at x=y=0.

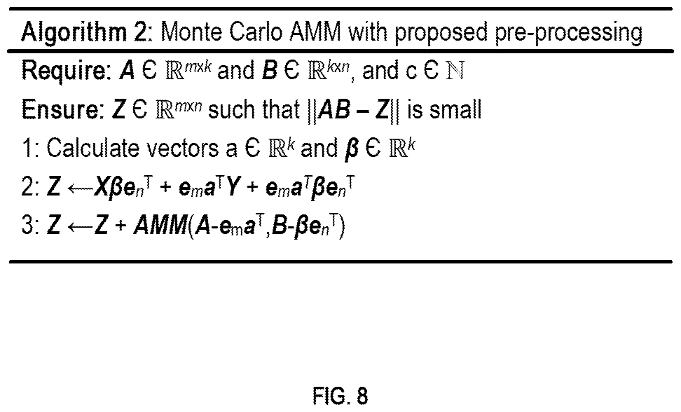

This theorem allows the maximization of the approximation performance of the example implementations. When incorporating this proposed method into the Monte Carlo AMM, Algorithm 2 is obtained to compute AB. FIG. 8 illustrates an example of pseudo code (Algorithm 2) of the Monte Carlo AMM with proposed pre-processing, in accordance with an example implementation.

Algorithms 1 and 2 are designed to efficiently compute an approximate solution for the matrix product AM, while minimizing computational overhead. Moreover, these algorithms possess inherent characteristics that make them highly compatible with GPU implementations, facilitating efficient execution without compromising memory transfer efficiency or computational performance.

The example implementations focus on replacing the steps of matrix multiplication performed on a GPU with the approximate matrix product.

The example implementations involve target devices capable of large-scale parallel computations, such as GPUs and FPGAs. The example implementations can involve:

(1) Replacing the exact matrix product with the approximate matrix product in applications that repeatedly execute matrix multiplication.

(2) Replacing the exact matrix product with the Monte Carlo Approximate Matrix Multiplications (AMMs) described in the embodiments in applications that repeatedly execute matrix multiplication.

(3) Replacing the exact matrix product with the approximate matrix product in the search for optimal solutions for interaction models, including the Ising model.

(4) Replacing the exact matrix product with the Monte Carlo AMMs described in the embodiments in the search for optimal solutions for interaction models, including the Ising model.

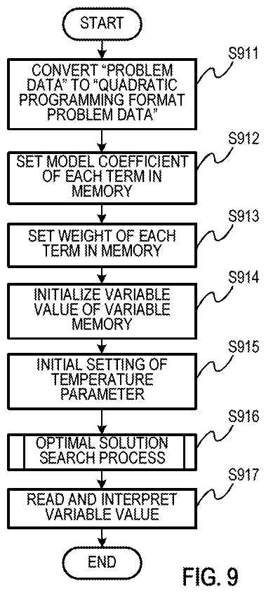

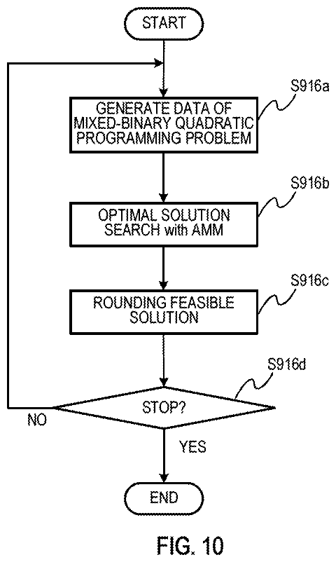

The overall flow of the optimization calculation incorporating the proposed method is shown in FIGS. 9 and 10.

FIG. 9 illustrates an example of the overall process, in accordance with an example implementation. At S911, the problem data is converted to quadratic programming format problem data. At S912, the model coefficient is set for each term in the memory. At S913, the weight of each term is set into the memory. S914, the variable value of the variable memory is initialized. At S915, the temperature parameter is initially set. At S916, the optimal solution search process is then executed, wherein at S917, the output variable values are read and interpreted.

FIG. 10 illustrates an example of the optimal solution search process S916, in accordance with an example implementation. At S916a, the flow generates the data of the mixed-binary quadratic programming problem. At S916b, the optimal solution search with AMM is executed using algorithm 1 or 2 as described above. At S916c the solutions can be rounded to a feasible solution. At S916d, a determination is made as to whether the iterations are complete; if not (No) the flow proceeds to S916a.

The proposed method of improving Monte Carlo Approximate Matrix Multiplication (AMM) on GPUs offers several significant benefits compared to the related art.

Enhanced Matrix Multiplication Approximation: The proposed example implementations improve the approximation of matrix products without increasing the computation time compared to conventional AMMs. This means that users can achieve more accurate results without sacrificing efficiency. By reducing the error in matrix product approximations, scientific and practical calculations relying on matrix multiplication, such as eigenvalue and eigenvector computations, can be performed with higher precision.

Compatibility with GPUs: The proposed example implementations are specifically designed to work well with parallel operations on GPUs. GPUs have immense computational power and are widely used in high-performance computing. By leveraging the potential of GPUs for fast and accurate matrix product calculations, the proposed example implementations can significantly speed up scientific and practical calculations, resulting in faster processing times and improved overall performance.

Versatility and Integration: The proposed example implementations can be easily incorporated into various algorithms that rely on matrix multiplication. This flexibility allows researchers and developers to enhance the efficiency and accuracy of existing algorithms without making significant modifications. By seamlessly integrating the method into different applications, users can benefit from unproved matrix product computations across a wide range of information processing tasks.

Optimal Hyperparameter Solution: The example implementations also provide an analytical solution for the optimal values of the hyperparameters. This means that users can fine-tune the method to achieve the best possible results for their specific use cases. Having an analytical solution for hyperparameter optimization simplifies the implementation process and allows users to achieve optimal performance without extensive trial and error.

Overall, the customer value derived from the proposed example implementations include faster and more accurate matrix product computations, improved precision in scientific and practical calculations, compatibility with GPUs for enhanced performance, easy integration into existing algorithms, and an analytical solution for optimizing hyperparameters. These benefits empower researchers and practitioners to accelerate their computations, achieve better results, and advance their work in fields such as data analysis, machine learning, scientific simulations, and optimization algorithms.

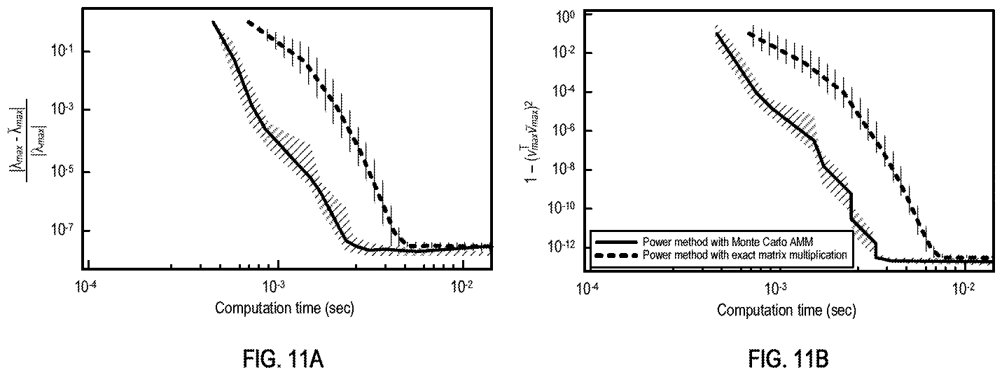

FIG. 11A and FIG. 11B illustrates an example of an improvement in computation time through use of the example implementations in comparison to the related art. Specifically, FIG. 11A illustrates an example of the variation of convergence over time when running CUDA programs of the power method on a GPU. Both FIGS. 11A and 11B share a common horizontal axis representing computation time. The vertical axis in FIG. 11A represents the relative error between the largest and estimated eigenvalue during iterations. In contrast, the vertical axis in FIG. 11B represents the deviation between the eigenvector corresponding to the largest eigenvalue and the estimated eigenvector during iterations. As shown in the example results of FIGS. 11A and 11B, the method with the Monte Carlo AMM demonstrates favorable convergence in both indicators.

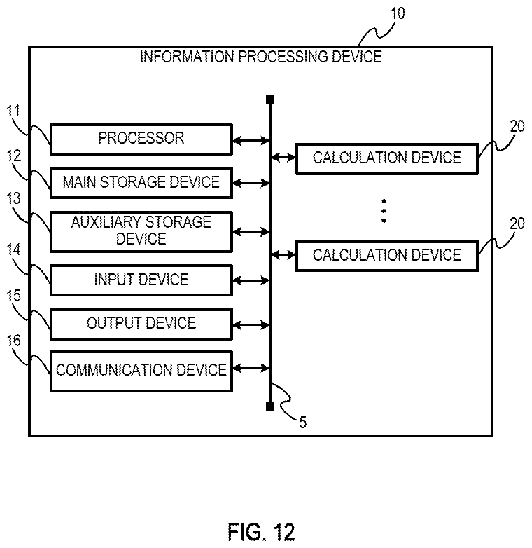

FIG. 12 illustrates a block diagram illustrating a schematic configuration of an information processing device upon which example implementations can be implemented. Specifically, FIG. 12 is an example of an information processing device that searches for the optimum solution of a mixed binary quadratic programming problem. As illustrated in the drawing, an information processing device 10 includes a processor 11, a main storage device 12, an auxiliary storage device 13, an input device 14, an output device 15, a communication device 16, one or more calculation devices 20, and a system bus 5 that communicably connects the devices. For example, the information processing device 10 may be realized by using a virtual information processing resource such as a cloud server of which a part or all is provided by a cloud system. Further, the information processing device 10 may be realized by, for example, a plurality of information processing devices that operate in cooperation with each other and are communicably connected to each other.

The processor 11 is configured, for example, by using a central processing unit (CPU) or a micro processing unit (MPU). The main storage device 12 is a device for storing programs or data, and is, for example, a read only memory (ROM), a static random-access memory (SRAM), a non-volatile ram (NVRAM), a mask read only memory (mask ROM), a programmable ROM (PROM), a random-access memory (RAM), a dynamic random-access memory (DRAM), and the like), and the like. The auxiliary storage device 13 is a hard disk drive, a flash memory, a solid-state drive (SSD), and an optical storage device (such as a compact disc (CD), a digital versatile disc (DVD)). The programs and data stored in the auxiliary storage device 13 are read into the main storage device 12 at any time.

The input device 14 is a user interface that receives input of information from the user, and is, for example, a keyboard, a mouse, a card reader, or a touch panel. The output device 15 is a user interface that provides information to the user, and is, for example, a display device (such as a liquid crystal display (LCD) and a graphic card) that visualizes various kinds of information, an audio output device (speaker), and a printing device. The communication device 16 is a communication interface that communicates with other devices and is, for example, a Network Interface Card (NIC), a wireless communication module, a universal serial interface (USB) module, and a serial communication module.

The calculation device 20 is a device that executes a process related to the optimum solution search of the mixed binary quadratic programming problem. The calculation device 20 may take the form of an expansion card to be mounted on the information processing unit 10, such as a graphics processing unit (GPU). The calculation device 20 is configured with hardware such as a complementary metal oxide semiconductor (CMOS) circuit, a field programmable gate array (FPGA), and an application specific integrated circuit (ASIC). The calculation device 20 includes a control device, a storage device, an interface for connecting to the system bus 5, and transmits and receives commands and information to and from the processor 11 via the system bus 5. The calculation device 20 may be, for example, one that is communicably connected to another calculation device 20 via a communication line and operates in cooperation with the other calculation device 20. The function realized by the calculation device 20 may be realized, for example, by causing a processor (such as CPU and GPU) to execute a program.

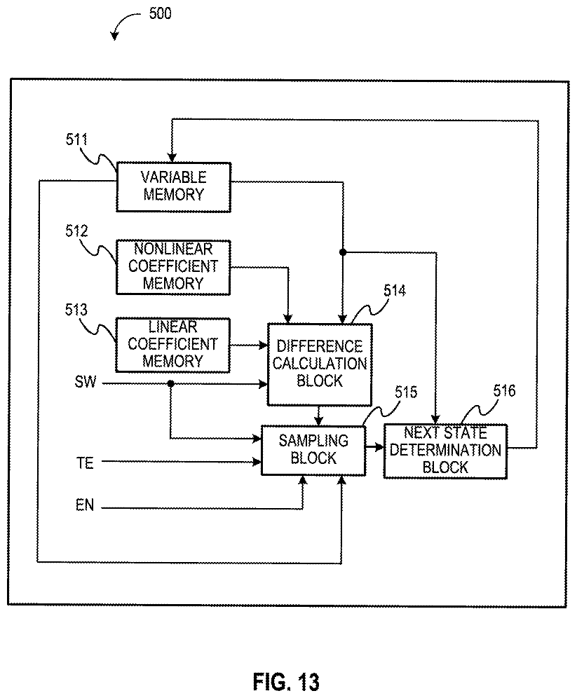

The calculation device 20 illustrated in FIG. 12 is described below in FIG. 13. One or a plurality of calculation devices 20 can be mounted.

In example implementations, the information processing device as illustrated in FIG. 12 can be configured to accelerate a process to search for optimal solutions for interaction models, the process involving iterative matrix multiplication between a first matrix and a second matrix. Processor 11 can be configured to control one or more calculation devices 20 to execute, using parallel processing, replacing the first matrix with a first approximate matrix and the second matrix with a second approximate matrix through adding a first set of constant values to the first matrix and a second set of constant values to the second matrix; executing a Monte Carlo Approximate Matrix Multiplication between the first approximate matrix and the second approximate matrix to generate an approximate matrix product; executing the process to search for the optimal solutions based on the approximate matrix product according to the interaction models; and providing the optimal solutions found from the process as shown with respect to FIGS. 7 and 8. The one or more calculation devices 20 can involve Graphics Processor Units (GPUs) or Field Programmable Gate Arrays (FPGAs).

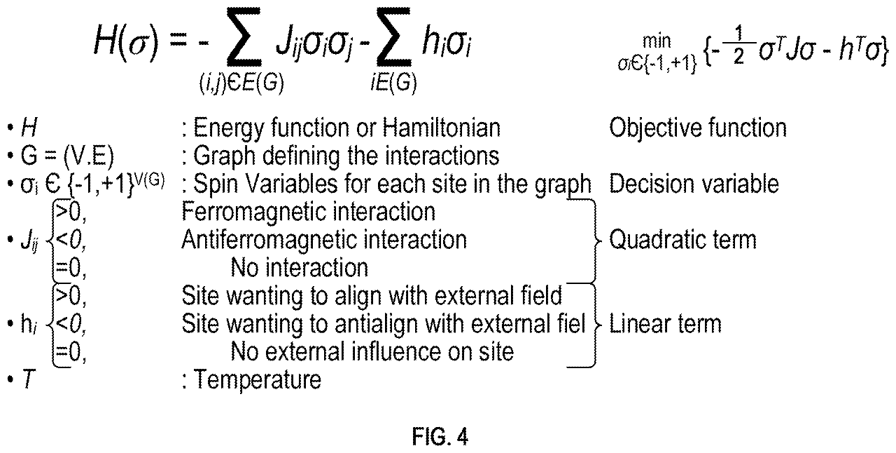

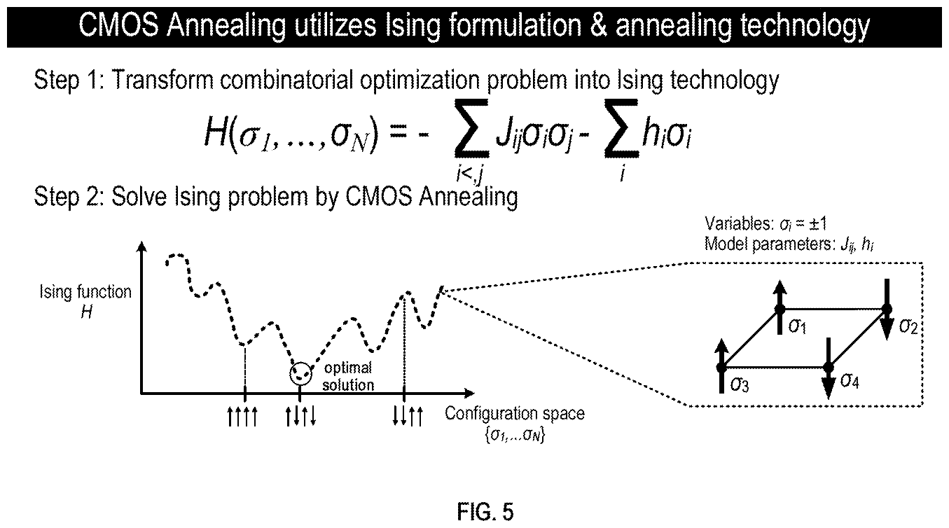

As described with respect to FIGS. 4 and 5, the process to search for the optimal solutions can be a Complementary Metal Oxide Semiconductor (CMOS) annealing process and the interaction models can be an Ising model, but the example implementations are not limited thereto. For example, the process can also be a neural network computation or an eigenvalue computation in accordance with the desired implementation.

As illustrated with respect to FIG. 8, the processor 11 can be configured to control the one or more calculation devices to execute, using parallel processing, the Monte Carlo Approximate Matrix Multiplication by determining a first vector based on the first set of constant values and a second vector based on the second set of constant values; and generating the approximate matrix product from the Monte Carlo Approximate Matrix Multiplication from a sum of: a matrix product result of the Monte Carlo Approximate Matrix multiplication, a vector product of the second vector with the first approximate matrix, a vector product of the second approximate matrix with the first vector, and an inner product involving the first set of constant values and the second set of constant values.

As illustrated with respect to the equations of FIGS. 7 and 8 the first set of constant values and the second set of constant values can be selected such that matrix multiplication result of the first matrix and the second matrix is equivalent to a sum of a matrix multiplication result of the first approximate matrix and the second approximate matrix, one or more vector multiplication operations involving the first approximate matrix and the second approximate matrix, and one or more inner product operations involving the first set of constant values and the second set of constant values.

FIG. 13 is a diagram for illustrating an operating principle of the calculation device 20 and is a block diagram of a system (hereinafter, referred to as a calculation system 500) that configures the calculation device 20. The calculation system 500 realizes a function of sampling the variable array x₁, . . . , x_{N} or the variable array y₁, . . . , y_{N} from the Boltzmann distribution at the temperature T. Hereinafter, an operating principle of the calculation device 20 is described with reference to FIG. 13.

As illustrated in the drawing, the calculation system 500 includes a variable memory 511, a nonlinear coefficient memory 512, a linear coefficient memory 513, a difference calculation block 514, a sampling block 515, and a next state determination block 516.

Information indicating the variables x₁, . . . , x_{N} and y₁, . . . , y_{N} described above is stored in the variable memory 511 of each of the calculation system 500.

The information indicating the matrix J is stored in the nonlinear coefficient memory 512. The matrix J is generally a symmetric matrix, and the usage amount of the nonlinear coefficient memory 512 can be reduced by using this symmetry. Information indicating the vector h is stored in the linear coefficient memory 513.

As illustrated in the drawing, a control signal EN, a weight signal SW, and a temperature signal TE are input to the calculation system 500.

The signal EN indicates which of the variable arrays x and y is updated, with a signal that periodically repeats the values of high (H) and low (L). For example, when EN is H, it is determined that the variable array xᵢ s updated, and when EN is L, it is determined that the variable array y is updated. According to the signal EN, the variables x₁, . . . , x_{N} are simultaneously updated, and the variables y₁, . . . , y_{N} are simultaneously updated. In FIG. 13, the signal EN is input only to the sampling block 515 for simplification, but the same is applied to other places, such as the variable memory that require this signal.

The signal SW is a signal indicating a vector of N elements representing the diagonal components of the diagonal matrix W.

The value of the matrix J stored in the nonlinear coefficient memory 512, the vector h stored in the linear coefficient memory 513, the signal SW, and the variable s (x or y) stored in the variable memory 511 are input to the difference calculation block 514. The difference calculation block 514 outputs (J+diag(w₁, . . . , w_{N})) y+h when the signal EN is H, and outputs J+diag(w₁, . . . , w_{N})) x+h when the signal EN is L. This output value corresponds to the above-mentioned Aᵢ.

The sampling block 515 receives the output of the difference calculation block 514, the signal SW, a signal TW that stores a value of the temperature parameter, the signal EN, and values of other variables. And the i-th element is randomly sampled and output from the truncated normal distribution represented by Expression 12 with −(2−yᵢ|) or more and (2−|yᵢ|) or less as the domain when the signal EN is H and −(2−|xᵢ|) or more and (2−|xᵢ|) or less as the domain when the signal EN is L.

The next state determination block 516 determines the next state of the variable based on one or more values output from the sampling block 515. If the MCMC update rule is defined as a simple heat-bath algorithm, the next state determination block 516 may receive only one output value of the sampling block 515 and write the received output value as it is to the variable memory 511. If a well-known over-relaxation method is used as the MCMC update rule, the next state determination block 516 receives a plurality of values from the sampling block 515 and the current value of the variable to be updated from the variable memory 511, selects one according to the over-relaxation method, and writes the value on the variable memory 511. As is well known, in the over-relaxation method, the next state is determined so that the correlation with the immediately preceding state is negative.

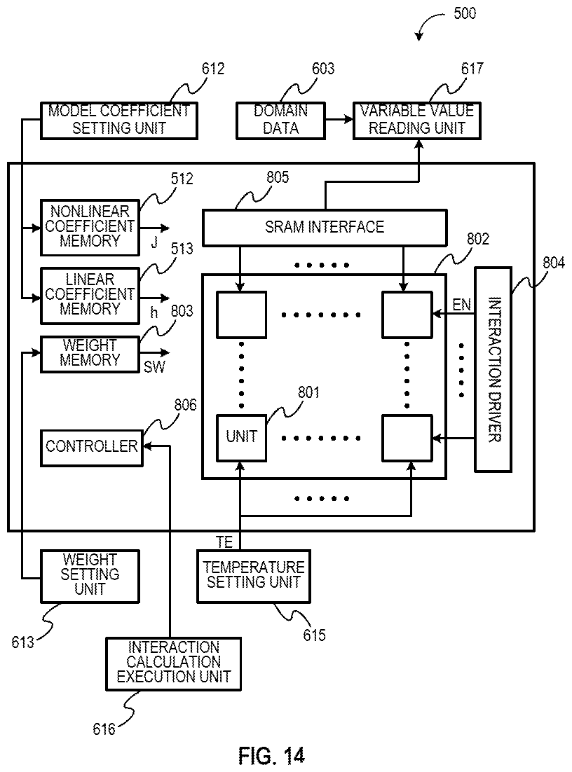

FIG. 14 is a detailed block diagram of the calculation system upon which example implementations can be applied. Specifically, FIG. 14 is a block diagram illustrating a circuit configuration example when the technology of SRAM is applied to the calculation system 500. A plurality of units 801 constitute an array unit 802. Such a configuration can be manufactured by applying the semiconductor manufacturing technology.

One unit 801 includes a multi-value memory 901 that stores any one of the variables x₁, . . . , x_{N} and y₁, . . . , y_{N} and a configuration for updating the value of the multi-value memory 901. That is, 2N units 801 are prepared.

The configuration example of FIG. 14 will be described with reference to the generalized configuration of FIG. 13. The data stored in the nonlinear coefficient memory 512 and the linear coefficient memory 513 is set by the model coefficient setting unit 612. The nonlinear coefficient memory 512 stores the N×N matrix J, which is commonly used by all units 801. Further, the N dimensional vector h is stored in the linear coefficient memory 513 and is commonly used by all the units 801. In order to reduce the circuit scale, these memories are common to each unit 801. Therefore, the nonlinear coefficient memory 512 and the linear coefficient memory 513 supply the coefficients J and h to all the units 801. However, the signal lines for that purpose are omitted in FIG. 8. In principle, each unit 801 may individually include the nonlinear coefficient memory 512 and the linear coefficient memory 513.

The vectors of the N elements (w₁, . . . , w_{N}) representing the diagonal components of the diagonal matrix W are stored in a weight memory 803. This data is set by the weight setting unit 613. Since the i-th unit that stores x, and y, uses the i-th component wᵢ, it is required to switch the value of the signal SW for each unit 801. In FIG. 8, the signal line for supplying the signal SW to the unit 801 is omitted.

The temperature signal TE supplied from the temperature setting unit 615 is supplied to all the units 801. The function and configuration of the temperature signal follow the prior art. The signal line that supplies the signal TE to the unit 801 is omitted.

An interaction driver 804 alternately inputs signals for allowing the update of the variable x and a signal for allowing the update of the variable y to each unit 801. As a result, the variables x₁ to x_{N} are updated at the same time, and the variables y₁ to y_{N} are updated at the same time.

An SRAM interface 805 writes and reads to and from the memory that stores the variables of the units 801 generated by applying the circuit configuration of the SRAM. The variable read after the process is completed in the calculation system 500 is sent to the variable value reading unit 617. The variable value reading unit 617 obtains a solution to the mixed binary quadratic programming problem by outputting the read variable as a continuous value or a binary value based on the domain data 603.

The controller 806 initializes the calculation system 500 and reports the end of the process according to the instruction of the interaction calculation execution unit 616.

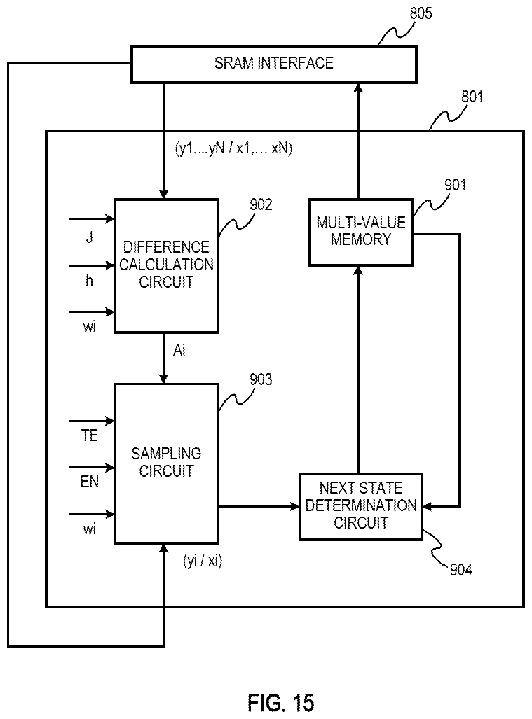

FIG. 15 is a block diagram of a unit constituting the calculation system upon which example implementations can be applied. Specifically, FIG. 15 is a diagram illustrating a circuit configuration example of one unit 801. The multi-value memory 901 that stores any one of the continuous variables x₁, . . . , x_{N} and y₁, . . . , y_{N} is included in one unit.

The difference calculation circuit 902 realizes the function of the difference calculation block 514. When the variable stored in the multi-valued memory 901 is any one of x₁, . . . , x_{N}, the vectors of (y₁, . . . , y_{N}) are input to the difference calculation circuit 902. When the variable stored in the multi-value memory 901 is any one of y₁, . . . , y_{N}, the vectors of (x₁, . . . , x_{N}) are input. These variable vectors are read and generated by an SRAM interface 805 from the multi-value memory 901 of another unit 801. Further, the N×N matrix J and the N-dimensional vector h, which are coefficients, are input. In addition, the weight wᵢ is input. The difference calculation circuit 902 outputs the value Aᵢ of the i-th row of (J+diag(w₁, . . . , w_{N})) s+h (s is a variable vector of x or y) with respect to these inputs.

A sampling circuit 903 realizes the function of the sampling block 515. The output Aᵢ, the signal EN, the signal SW, the signal TE, and yᵢ if the variable stored in the multi-value memory 901 is xᵢ, or xᵢ if the variable stored in the multi-valued memory 901 is yᵢ are input to the sampling circuit 903. Then, the candidate of the next state of the variable is sampled from the existence probability p(sᵢ) of the variable sᵢ.

A state determination circuit 904 determines the next state of the variable based on one or a plurality of candidates output from the sampling circuit 903. In the state determination circuit 904, for example, when the over-relaxation method is followed, if a plurality of candidates are obtained from the sampling circuit 903, a candidate whose correlation with the state immediately before the multivalued memory 901 is negative is selected, and the next state is determined. The determined next state is stored in the multi-value memory 901.

In the above, the difference calculation block 514, the sampling block 515, and the next state determination block 516 are assumed to be hardware such as FPGA. However, for example, software utilizing a large number of calculation devices mounted on a GPU, a vector type computer, or the like can be implemented. By providing a large number of units 801 in this manner, variables can be updated in parallel.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for accelerating a process to search for optimal solutions for interaction models, the process involving iterative matrix multiplication between a first matrix and a second matrix, the method comprising:
replacing the first matrix with a first approximate matrix and the second matrix with a second approximate matrix through adding a first set of constant values to the first matrix and a second set of constant values to the second matrix;
executing a Monte Carlo Approximate Matrix Multiplication between the first approximate matrix and the second approximate matrix to generate an approximate matrix product;
executing the process to search for the optimal solutions based on the approximate matrix product according to the interaction models; and
providing the optimal solutions found from the process.

2. The method of claim 1, wherein the method is executed using parallel processing on Graphics Processor Units (GPUs) or Field Programmable Gate Arrays (FPGAs).

3. The method of claim 1, wherein the process to search for the optimal solutions is a Complementary Metal Oxide Semiconductor (CMOS) annealing process and the interaction models comprises Ising model.

4. The method of claim 1, wherein the process is a neural network computation.

5. The method of claim 1, wherein the process is an eigenvalue computation.

6. The method of claim 1, wherein the executing the Monte Carlo Approximate Matrix Multiplication comprises:
determining a first vector based on the first set of constant values and a second vector based on the second set of constant values;
generating the approximate matrix product from the Monte Carlo Approximate Matrix Multiplication from a sum of: a matrix product result of the Monte Carlo Approximate Matrix multiplication, a vector product of the second vector with the first approximate matrix, a vector product of the second approximate matrix with the first vector, and an inner product involving the first set of constant values and the second set of constant values.

7. The method of claim 1, wherein the first set of constant values and the second set of constant values are selected such that matrix multiplication result of the first matrix and the second matrix is equivalent to a sum of a matrix multiplication result of the first approximate matrix and the second approximate matrix, one or more vector multiplication operations involving the first approximate matrix and the second approximate matrix, and one or more inner product operations involving the first set of constant values and the second set of constant values.

8. An information processing device configured to accelerate a process to search for optimal solutions for interaction models, the process involving iterative matrix multiplication between a first matrix and a second matrix, the information processing device comprising:
a processor, configured to control one or more calculation devices to execute, using parallel processing:
replacing the first matrix with a first approximate matrix and the second matrix with a second approximate matrix through adding a first set of constant values to the first matrix and a second set of constant values to the second matrix;
executing a Monte Carlo Approximate Matrix Multiplication between the first approximate matrix and the second approximate matrix to generate an approximate matrix product;
executing the process to search for the optimal solutions based on the approximate matrix product according to the interaction models; and
providing the optimal solutions found from the process.

9. The information processing device of claim 8, wherein the one or more calculation devices comprises Graphics Processor Units (GPUs) or Field Programmable Gate Arrays (FPGAs).

10. The information processing device of claim 8, wherein the process to search for the optimal solutions is a Complementary Metal Oxide Semiconductor (CMOS) annealing process and the interaction models comprises Ising model.

11. The information processing device of claim 8, wherein the process is a neural network computation.

12. The information processing device of claim 8, wherein the process is an eigenvalue computation.

13. The information processing device of claim 8, wherein the processor is configured to control the one or more calculation devices to execute, using parallel processing, the Monte Carlo Approximate Matrix Multiplication by:
determining a first vector based on the first set of constant values and a second vector based on the second set of constant values;
generating the approximate matrix product from the Monte Carlo Approximate Matrix Multiplication from a sum of: a matrix product result of the Monte Carlo Approximate Matrix multiplication, a vector product of the second vector with the first approximate matrix, a vector product of the second approximate matrix with the first vector, and an inner product involving the first set of constant values and the second set of constant values.

14. The information processing device of claim 8, wherein the first set of constant values and the second set of constant values are selected such that matrix multiplication result of the first matrix and the second matrix is equivalent to a sum of a matrix multiplication result of the first approximate matrix and the second approximate matrix, one or more vector multiplication operations involving the first approximate matrix and the second approximate matrix, and one or more inner product operations involving the first set of constant values and the second set of constant values.

15. A non-transitory computer readable medium, storing instructions for accelerating a process to search for optimal solutions for interaction models, the process involving iterative matrix multiplication between a first matrix and a second matrix, the instructions comprising:
replacing the first matrix with a first approximate matrix and the second matrix with a second approximate matrix through adding a first set of constant values to the first matrix and a second set of constant values to the second matrix;
executing a Monte Carlo Approximate Matrix Multiplication between the first approximate matrix and the second approximate matrix to generate an approximate matrix product;
executing the process to search for the optimal solutions based on the approximate matrix product according to the interaction models; and
providing the optimal solutions found from the process.
